(19) United States
(12) Patent Application Publication
(10) Pub. No.: US 2012/0179810 A1
(43) Pub. Date: Jul. 12, 2012

(54) METHOD AND APPARATUS FOR IMPROVING MANAGEMENT OF NETWORK RESOURCES FOR DEVICES

(75) Inventors: Raul I. Contreras Delpiano, San Diego, CA (US); Manuel Eduardo Jaime, Solana Beach, CA (US); Oliver Michaelis, San Diego, CA (US); Andrew A. Wood, San Diego, CA (US)

(73) Assignee: QUALCOMM INCORPORATED, San Diego, CA (US)

(21) Appl. No.: 13/004,623

(22) Filed: Jan. 11, 2011

(51) Int. Cl. G06F 15/173

(52) U.S. Cl. 709/224

(57) ABSTRACT

Methods and apparatuses are provided that facilitate selecting one or more front links or backhaul links for a device for facilitating communications with one or more service providers. A small base station can include multiple front link and backhaul link options, and one or more link options can be selected for a given device based on a utility function, one or more policies, etc., according to various parameters related to the device, to the small base station, to the service provider, and/or the like.

### BACKGROUND

1. Field

The following description relates generally to network communications, and more particularly to managing network resources for one or more devices.

2. Background

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), evolution data optimized (EV-DO), etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth. In addition, mobile devices can communicate with other mobile devices (and/or base stations with other base stations) in peer-to-peer wireless network configurations. In an example, base stations can include small base stations, such as femtocell, picocell, relay nodes, or similar base stations, that facilitate communicating with a core network over one or more interfaces, such as a wired backhaul link, a wireless backhaul link, and/or the like, on a smaller scale than a macrocell base station. Moreover, devices can utilize more than one interface for communicating with a base station, such as a 3GPP interface, an IEEE 802.11 (WiFi) or similar network interface, etc.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more embodiments and corresponding disclosure thereof, various aspects are described in connection with facilitating dynamically selecting one or more front links or backhaul links for device communications based at least in part on one or more parameters. For example, a small base station can establish connection(s) one or more backhaul interfaces, and offer one or more front link interfaces. In this regard, a device can request communication from the small base station, and the small base station can dynamically select one or more of the front links useable by the device and one or more of the backhaul links to facilitate device communication with one or more networks or related service providers based on the one or more parameters. In one example, the small base station can select the front links or backhaul links based at least in part on a utility function, one or more policies, one or more parameters, and/or the like to provide improved management of network resources.

According to an example, a method of communicating over multiple link options is provided that includes receiving one or more parameters and computing a utility function for communicating with a device based at least in part on the one or more parameters. The method also includes dynamically selecting one or more front links for communicating with the device and one or more backhaul links to one or more service providers for serving the device based at least in part on the utility function.

In another aspect, an apparatus for selecting link options for device communications is provided that includes at least one processor configured to obtain one or more parameters and compute a utility function for a device based at least in part on the one or more parameters. The at least one processor is further configured to dynamically select one or more front links for communicating with the device and one or more backhaul links to one or more service providers for serving the device based at least in part on the utility function. In addition, the wireless communications apparatus includes a memory coupled to the at least one processor.

In yet another aspect, an apparatus for communicating over multiple link options is provided that includes means for receiving one or more parameters and means for computing a utility function for communicating with a device based at least in part on the one or more parameters. The apparatus further includes means for dynamically selecting one or more front links for communicating with the device and one or more backhaul links to one or more service providers for serving the device based at least in part on the utility function.

Still, in another aspect, a computer-program product is provided selecting link options for device communications including a computer-readable medium having code for causing at least one computer to obtain one or more parameters and code for causing the at least one computer to compute a utility function for a device based at least in part on the one or more parameters. The computer-readable medium further includes code for causing the at least one computer to dynamically select one or more front links for communicating with the device and one or more backhaul links to one or more service providers for serving the device based at least in part on the utility function.

Moreover, in an aspect, an apparatus for communicating over multiple link options is provided that includes a parameter receiving component for obtaining one or more parameters and a utility function component for computing a utility function for communicating with a device based at least in part on the one or more parameters. The apparatus further includes a link selecting component for dynamically selecting one or more front links for communicating with the device and one or more backhaul links to one or more service providers for serving the device based at least in part on the utility function.

According to another example, a method for selecting communication links is provided that includes receiving one or more utility functions or policies from a small base station and selecting one or more front links for communicating with the small base station based at least in part on the one or more utility functions or policies.

In another aspect, an apparatus for selecting communication links is provided that includes at least one processor configured to receive one or more utility functions or policies from a small base station and select one or more front links for communicating with the small base station based at least in part on the one or more utility functions or policies. In addition, the wireless communications apparatus includes a memory coupled to the at least one processor.

In yet another aspect, an apparatus for selecting communication links is provided that includes means for receiving one or more utility functions or policies from a small base station. The apparatus further includes means for selecting one or more front links for communicating with the small base station based at least in part on the one or more utility functions or policies.

Still, in another aspect, a computer-program product is provided for selecting communication links including a computer-readable medium having code for causing at least one computer to receive one or more utility functions or policies from a small base station. The computer-readable medium further includes code for causing the at least one computer to select one or more front links for communicating with the small base station based at least in part on the one or more utility functions or policies.

Moreover, in an aspect, an apparatus for selecting communication links is provided that includes a management information receiving component for obtaining one or more utility functions or policies from a small base station. The apparatus further includes a managing component for selecting one or more front links for communicating with the small base station based at least in part on the one or more utility functions or policies.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example system for communicating with various service providers and devices over various links.

FIG. 2 illustrates an example system for selecting one or more communication links for a device.

FIG. 3 illustrates an example system for provisioning management information related to one or more devices.

FIG. 4 illustrates an example system that facilitates communicating management information to one or more devices.

FIG. 5 illustrates an example methodology that selects one or more communication links for a device.

FIG. 6 illustrates an example methodology that establishes at least one communication link for a device based on one or more utility functions or policies.

FIG. 7 illustrates an example methodology for communicating management information to one or more devices.

FIG. 8 illustrates an example methodology that facilitates selecting one or more communication links based on received utility functions or policies.

FIG. 9 illustrates an example mobile device that selects one or more communication links based on received utility functions or policies.

FIG. 10 illustrates an example system that facilitates selecting one or more communication links for a device.

FIG. 11 illustrates an example system for selecting one or more communication links for a device.

FIG. 12 illustrates an example system that selects one or more communication links based on received utility functions or policies.

FIG. 13 illustrates an example wireless communication system in accordance with various aspects set forth herein.

FIG. 14 illustrates an example wireless network environment that can be employed in conjunction with the various systems and methods described herein.

FIG. 15 illustrates a wireless communication system, configured to support a number of devices, in which the aspects herein can be implemented.

FIG. 16 illustrates an exemplary communication system to enable deployment of femtocells within a network environment.

FIG. 17 illustrates an example of a coverage map having several defined tracking areas.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As described further herein, a small base station, such as a femtocell, picocell, relay node, etc. can be equipped to communicate over multiple backhaul links and/or multiple front links. The small base station can determine one or more of the front links and one or more of the backhaul links for communications from a device based at least in part on one or more parameters. For example, the one or more parameters can relate to the device, to the network, to the small base station, and/or the like, as described further herein. In addition, the one or more parameters can be utilized in computing a utility function for determining the one or more front links and/or backhaul links. Moreover, policies can be defined to preempt or further restrict the utility function. Thus, one or more front links or backhaul links are selected for a device to improve network resource utilization via the small base station.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, evolved Node B (eNB), or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

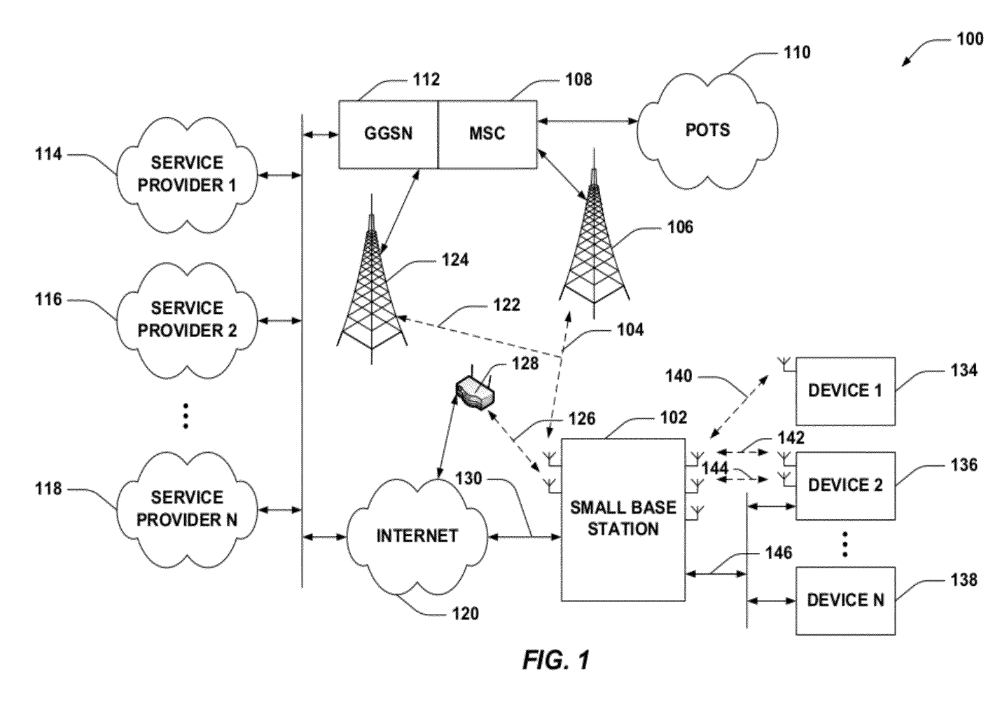

Referring to FIG. 1, illustrated is a communication system 100 that facilitates improving management of network resources. System 100 includes small base station 102 comprising a number of backhaul links and front links, as described. For example, as shown, small base station 102 can communicate over backhaul link 104 (e.g., which can be a radio access network (RAN) backhaul link) with a macrocell base station 106 that accesses a mobile switching center (MSC) 108. The MSC 108 can communicate with a plain old telephone service (POTS) 110 to provide voice call functionality to small base station 102 and/or other base stations connected to MSC 108. In addition, MSC 108 can be coupled to a gateway general packet radio service (GPRS) support node (GGSN) 112 or other gateway node to provide access to one or more service providers, such as service provider 1 114, service provider 2 116, service provider N 118, etc. (e.g., over one or more networks), Internet 120, and/or the like. For example, the service providers can be additional networks or components thereof that provide substantially any data, voice, or other communication services for one or more devices, such as a mobile network operator (MNO), an internet service provider (ISP), a home management service provider, a video streaming service provider, a web server, etc.

In another example, small base station 102 can communicate over backhaul link 122 with another macrocell base station 124 that communicates directly with the GGSN 112 or other gateway node to access the one or more service providers 114, 116, 118, etc., Internet 120, and/or the like. In addition, for example, small base station 102 can communicate over backhaul link 126 (e.g., which can be a IEEE 802.11 (WiFi) backhaul link) with a WiFi hotspot 128. In this example, WiFi hotspot 128 can provide access to Internet 120, to service providers 114, 116, 118, etc. via Internet 120, to the GGSN 112, MSC 108, and/or POTS 110 via Internet 120, and/or the like. In yet another example, small base station 102 can communicate with Internet 120 over wired backhaul 130 (e.g., which can be a local area network (LAN) backhaul, such as a cable broadband connection, digital subscriber line (DSL), T1, or similar Internet connection) for similar access.

Furthermore, small base station 102 can communicate with one or more devices, such as device 1 134, device 2 136, device N 138, etc. over one or more front links. As described, for example small base station 102 can dynamically select one or more backhaul links, as described above, for each device 134, 136, 138, etc. and/or one or more front links for communicating with each device 134, 136, 138, etc. Thus, as depicted, small base station 102 can select front link 140 (e.g., which can be a RAN front link) for communicating with device 134. In addition, small base station 102 can select front links 142 (e.g., which can be a RAN front link) and 144 (e.g., which can be a WiFi front link) for communicating with device 136. Also, small base station 102 can select a direct front link 146 (e.g., which can be a LAN front link, etc.) for device 2 136 and device N 138.

As described above and further herein, small base station 102 can select the depicted front links 140, 142, 144, and 146 for each device 134, 136, 138, etc. based at least in part on a utility functions, one or more parameters, one or more policies, and/or the like. For example, the one or more parameters can relate to communications at small base station 102, at the respective device 134, 136, 138, etc., and/or the like, and can be received from the device, one or more of the service providers 114, 116, or 118, measured or determined by small base station 102, etc. In another example, the utility function can relate to maximizing or optimizing one or more aspects of the communication. In addition, the policies can be defined by the devices 134, 136, 138, etc., the small base station 102, service providers 114, 116, 118, etc., and/or the like. Similarly, as described, small base station 102 can select one or more of backhaul links 104, 122, 126, or 130, in this example, for facilitating communications from the devices 134, 136, 138, etc. to GGSN 112, MSC 108, POTS 110, the service providers 114, 116, 118, etc., Internet 120, and/or the like.

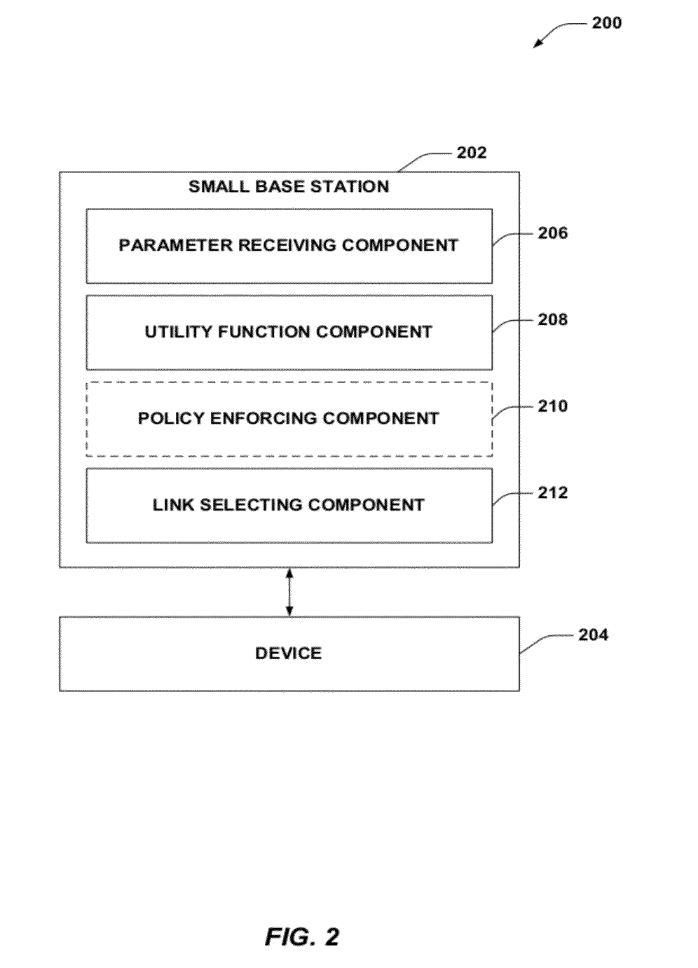

Turning to FIG. 2, an example communication system is illustrated that facilitates selecting one or more front links and/or backhaul links for communicating with one or more devices. System 200 includes a small base station 202 that communicates with device 204 over one or more front links, as described. For example, small base station 202 can be a femtocell or picocell base station, a relay node, a device communicating in peer-to-peer mode, etc., and can have one or more backhaul link connections to one or more service providers via other network devices, base stations, access points, gateways, etc., as described. Device 204 can be a UE, modem (or other tethered device), computer, server, gateway, relay node, base station, home appliance, and/or substantially any device that can receive access to one or more networks for communicating thereover or service providers for communicating therewith.

Small base station 202 comprises a parameter receiving component 206 for obtaining one or more parameters, a utility function component 208 that computes a utility function for communicating with a device over one or more front links and/or utilizing one or more backhaul links for device communications based at least in part on the one or more parameters, and an optional policy enforcing component 210 that modifies the utility function or one or more outputs thereof according to one or more policies. Small base station 202 also comprises a link selecting component 212 that dynamically determines one or more front links for establishing communication with a device and/or one or more backhaul links for providing device communications to one or more networks, or nodes thereof, based at least in part on the utility function.

According to an example, device 204 can request connection establishment with small base station 202. In another example, device 204 can be currently communicating with small base station 202 over one or more front links. In either case, small base station 202 can dynamically select one or more front links and/or backhaul links for device 204 communications, as described herein (e.g., based on a connection request or other event, based on a timer, etc.). For example, parameter receiving component 206 can obtain one or more parameters (e.g., from device 204, small base station 202, another network component, etc.), and utility function component 208 can compute a utility function for device 204 related to one or more available front links and/or backhaul links based at least in part on the one or more parameters. For example, the utility function can relate to maximizing some aspect of communications from device 204 in view of one or more other aspects by selecting communication links to attain such maximization. For example, the utility function can aim to maximize data rate according to priorities related to data types, maximize SNR based on a desired QoS, etc. based on available communication links.

In one example, policy enforcing component 210 can modify an output of the utility functions, modify the one or more parameters, override the utility function, etc., based at least in part on one or more policies. For example, the one or more policies can relate to utilizing the one or more front links to communicate over the one or more backhaul links. For instance, an example policy can relate to using a certain communication link according to a condition or event (e.g., based on content type, a desired QoS or data rate, and/or the like), as described further herein.

Thus, for example, based at least in part on the output of the utility function and/or the one or more policies, link selecting component 212 can determine one or more front links over which to establish a connection with device 204, and/or link selecting component 212 can determine one or more backhaul links over which to provide device 204 communications to one or more service providers, networks, or related nodes of the networks. In another example, device 204 can additionally or alternatively comprise one or more components of small base station 202, such as parameter receiving component 206, utility function component 208, policy enforcing component 210 and/or link selecting component 212. In this regard, for example, device 204 can determine one or more front links for communicating with small base station 202 based at least in part on a computed utility function based on one or more parameters and/or one or more enforced policies, as described herein. Moreover, as described further below in this regard, device 204 can receive the utility function, one or more policies, etc. from small base station 202.

In one example, the one or more parameters can relate to an objective of a communication link, such as a link type, desired data for the link, desired data rate or quality-of-service (QoS) for the link, signal-to-noise ratio (SNR) of the link, a latency, and/or the like, which can be provided by device 204, in one example. In addition, for example, the one or more parameters can be specific to device 204 or a user thereof (e.g., one or more device capabilities, a battery status, a content request, subscriber account limitations). In another example, the one or more parameters can relate to small base station 202 (e.g., a local resource availability at small base station 202, resource availability on one or more of the backhaul links, SNR of the one or more backhaul links, network traffic, etc.), and/or the like, and can be measured or otherwise determined by the small base station 202. In yet another example, the one or more parameters can be extrinsic to communications, such as current time of day, date, etc. In any case, the parameter receiving component 206 can obtain one or more of such parameters, and the utility function component 208 can determine one or more front links or backhaul links based at least in part on the parameters.

In an example, front link interfaces available at small base station 202, from which link selecting component 212 can choose, can include at least one of a RAN, LAN, wireless LAN (WLAN), low-rate wireless personal area networks (LR-WPAN), home appliance networks, and/or the like. In addition, for example, backhaul link interfaces at small base station 202 can include RAN, LAN, WLAN, broadband Internet connections, such as cable, DSL, T1, etc., and/or the like. Moreover, for example, link selecting component 212 can determine the backhaul link to utilize based at least in part on the determined front link, and/or vice versa. In one example, the selected link can be an input to utility function component 208 to determine another link. Moreover, utility function component 208 can receive one or more utility functions, and/or policy enforcing component 210 can receive one or more policies, from a network device (e.g., related to one or more available backhaul links), from a service provider accessible over the one or more backhaul links, from device 204 or other devices, from a hardcoding, network specification, configuration, and/or the like, etc.

For example, device 204 can provide one or more parameters to small base station 202 regarding initiating a voice call. As described, this can be performed upon requesting connection establishment with small base station 202, while communicating therewith, and/or the like. In this example, utility function component 208 can determine that a RAN backhaul link to a macrocell that can access a GSM or similar network can be used for receiving and responding to device 204 communications regarding the voice call. In addition, utility function component 208 can determine that a RAN front link to device 204 is sufficient to handle the voice call. Thus, link selecting component 212 can select the RAN front link and the RAN backhaul link to the circuit switched network for device 204. Moreover, small base station 202 can establish connection with device 204 over the RAN front link, if not already established.

In an example, however, parameter receiving component 206 can additionally obtain one or more parameters from the network related to the backhaul link, the macrocell base station, and/or the like, that indicate the network related to the macrocell access point, or the macrocell access point itself, is near or beyond resource capacity. In this regard, the utility function component 208 can compute the utility function to determine to utilize a WiFi or LAN backhaul link (e.g., which can perform voice over internet protocol (VoIP)) for device 204, and link selecting component 212 can accordingly select the WiFi or LAN backhaul link for device 204. For example, it is to be appreciated that utility function component 208 can consider at least one of the following parameters received by parameter receiving component 206 in determining the backhaul link in this example: time, network availability, cost, network or device 204 features, signal strength of the base station, traffic load at the base station, latency of the WiFi or LAN backhaul link, packet loss over the WiFi or LAN backhaul link, and/or the like. Thus, for example, utility function component 208 can compute the utility function to maximize at least one of the one or more parameters to determine a backhaul link for device 204.

In one specific example, utility function component 208 can use a utility function that aims to minimize traffic cost of devices subject to a latency requirement of less than 500 milliseconds (ms). Additionally, in this example, small base station 202 can have an established DSL backhaul link and a RAN backhaul link, as described, and routing traffic through the DSL can be less costly in this example. In this example, utility function component 208 can compute a utility function upon receiving a request from device 204, according to a timer, and/or the like, that measures latency over the DSL backhaul link. Upon receiving voice call data from device 204, if utility function component 208 determines the latency of DSL is less than 500 ms, it can cause link selecting component 212 to select the DSL backhaul for the voice call (e.g., which can establish the voice call over VoIP), or the RAN backhaul otherwise.

Additionally, in this specific example, policy enforcing component 210 can implement one or more policies to modify and/or override the utility function. For example, policy enforcing component 210, according to a stored policy, can determine whether the voice call is an emergency call (e.g., 911), and can cause link selecting component 212 to select the RAN backhaul link for device 204 regardless of the utility function component 208 output. For example, this can occur before, during, or after computation of the utility function. Similarly, policy enforcing component 210 can, according to a policy, cause link selecting component 212 to choose the DSL backhaul link for all data (e.g., non-voice call) traffic, if available. For example, policy enforcing component 210 can receive such policies as part of small base station 202, from one or more network components or service providers, (e.g., over the backhaul links), and/or the like. In addition, policy enforcing component 210 can implement conflict resolution for the case where policies received from two sources conflict. For example, the policies can be based on device 204 or user behavior, content type, network conditions, etc. Also, as described further herein in one example, policy enforcing component 210 can push the policies to device 204 for local enforcement at device 204.

Moreover, in another example, device 204 can be a smartphone, tablet, or similar device that can access the Internet through both cellular networks (using protocols such as GPRS, UMTS, high speed packet access (HSPA) and evolution data optimized (EV-DO)) and WLAN access points (using protocols such as WiFi). In this example, small base station 202 can include RAN and WLAN front link interfaces and can be located in a user's home, for example. A service provider, such as a MNO, ISP, home management service provider, etc. (not shown), can load policies and utility functions into small base station 202, which can be received by policy enforcing component 210 and utility function component 208, as described, to improve the user experience. For example, the policies from the MNO can maximize user experience as a function of data throughput and battery life of device 204 for the current session. Thus, for example, device 204 can provide one or more parameters regarding battery life to small base station 202, and parameter receiving component 206 can obtain the one or more parameters, providing the one or more parameters to utility function component 208.

In addition, in this example, the utility function computed by utility function component 208 can relate to selecting one or more optimal front and/or backhaul links based at least in part on battery life. For example, where the battery life measured by device 204 is running low (e.g., below a threshold defined by the utility function), in this example, the utility function computed by utility function component 208 can output to select the more energy-efficient front link (e.g., RAN) to connect device 204 to the Internet for an uninterrupted session. Link selecting component 212 can select the RAN front link for device 204 if not already selected. On the other hand, if the battery life is at least at a threshold level, the utility function computed by utility function component 208 can output to select WLAN front link (e.g., or both RAN and WLAN) to maximize data throughput. Link selecting component 212, as described, can so select the front link(s) for device 204. In yet another example, a policy defined by the MNO can specify to establish an Internet session using WLAN for all streaming video content. In this regard, the policy enforcing component 210 can override the utility function component 208, in one example, such that link selecting component 212 selects or maintains a WLAN front link where the content being delivered to device 204 is streaming video. In addition, link selecting component 212 can select one or more backhaul links for device 204 depending on the utility function and/or policies in this example. It is to be appreciated that many other content type policies and/or utility functions can be utilized in this regard.

In yet another example, policy enforcing component 210 can receive and institute policies based at least in part on service priority. For example, small base station 202 can provide a front link connection to a home appliance or related home management system that can monitor security, power, heating, ventilating, and air conditioning (HVAC), smoke detectors, etc., in a user's home. In this regard, for example, small base station 202 can have dedicated front links and/or backhaul links for such high-priority data (or at least for higher priority for data related to security, power, smoke detectors, etc.). In addition, utility function component 208 can compute a utility function that can utilize secondary front links and/or backhaul links where one or more parameters received or measured from the home appliance or related home management system, and/or a related service provider indicate a bad or failed connection over the dedicated links. In a similar example, a service provider for home management systems can push utility functions and/or policies to small base station 202, which can perform power management of one or more devices, such as device 204, communicating with small base station 202 according to the received utility functions and/or policies, as described in further detail below.

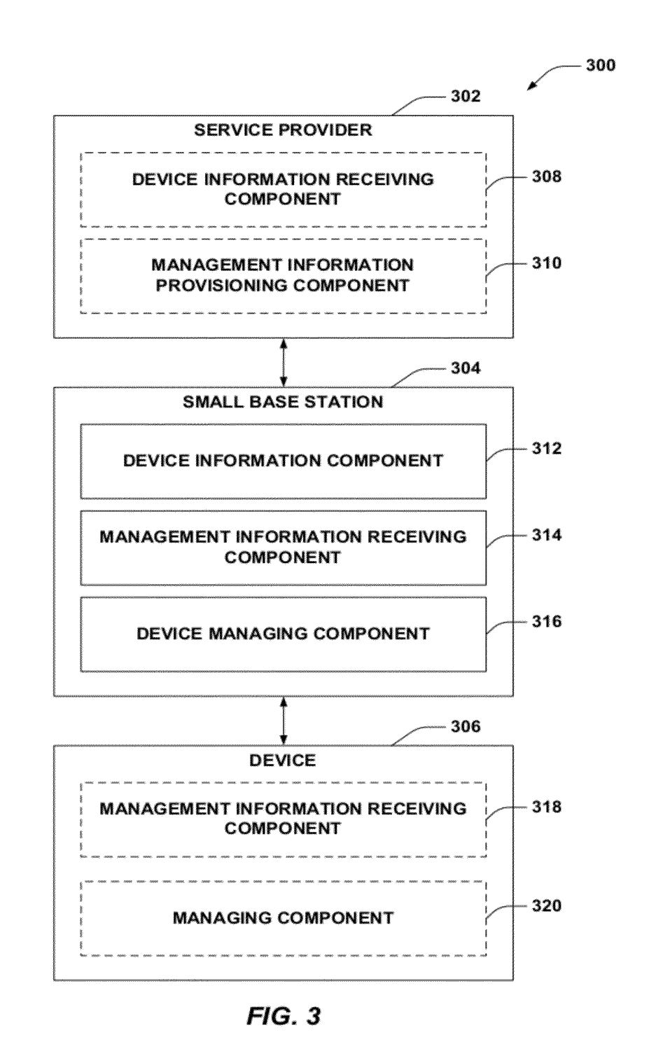

Referring to FIG. 3, illustrated is an example communication system 300 that facilitates managing one or more devices based at least in part on information received from a service provider. System 300 can include a service provider 302, such as a MNO, ISP, home management service provider, etc., as described, that communicates with a small base station 304 to provide one or more services to one or more devices, such as device 306. As described, small base station 304 can be a femtocell, picocell, or similar base station, a relay node, device in peer-to-peer mode, a portion thereof, etc., and can comprise one or more components of small base station 202 in FIG. 2 to provide functionalities described above, for example. Device 306 can be a UE, modem (or other tethered device), a computer, server, etc., as described.

Service provider 302 can optionally comprise a device information receiving component 308 that obtains information regarding one or more devices communicating with small base station 304, and a management information provisioning component 310 that provides a management function, utility function, one or more policies, etc. to a small base station for managing one or more aspects of the one or more devices. Small base station 304 comprises a device information component 312 that generates or otherwise determines information regarding one or more devices, a management information receiving component 314 that obtains a management function, utility function, one or more policies, etc. for the one or more devices based at least in part on the device information, and a device managing component 316 that manages one or more aspects of the one or more devices. In addition, device 306 can optionally comprise a management information receiving component 318 that obtains a management function, utility function, one or more policies, etc. from a small base station, and a managing component 320 that performs one or more functions for device 306 based at least in part on the management function, utility function, one or more policies, etc., as received.

According to an example, small base station 304 can communicate with a plurality of devices, such as device 306, to facilitate communicating between the devices and service provider 302. For example, small base station 304 can allow device 306 to receive mobile network access from service provider 302, where service provider 302 is an MNO. In an example, device information component 312 can determine one or more aspects of device 306 and/or other devices communicating with small base station 304 (e.g., substantially all devices on all available front links), such as quantity of devices, capabilities of the devices, etc., and can optionally provide information regarding the one or more aspects to service provider 302. In one example, device information component 312 can provide information only for devices related to service provider 302. Device information receiving component 308 can obtain the information, and management information provisioning component 310 can provide information for managing device 306 to small base station 304. For example, the information can include a management function, which can relate to substantially any function that can be performed for device 306, performed by device 306, and/or the like, such as execution of an application or service for or on the device 306, etc. In another example, the information can relate to a utility function, one or more policies, etc., as described above. Thus, in one example, service provider 302 can compute the utility function.

In addition, for example, management information receiving component 314 can obtain the information from service provider 302, as described. Where the information relates to a management function, utility function, one or more policies, etc. for performing at the small base station 304, small base station 304 can accordingly perform the management function, use the utility function or one or more policies in computing one or more front links or backhaul links for device 306 (as described), and/or the like. Moreover, for example, device managing component 316 can communicate the management function, utility function, one or more policies, etc. to the device 306, in one example, for local performance at device 306. In this example, management information receiving component 318 can receive the management function, utility function, one or more policies, etc., and managing component 320 can perform the management function, use the utility function and/or one or more policies in determining one or more front links to utilize in communicating with small base station 202, and/or the like. In one example, where management information receiving component 318 obtains a utility function and/or policies from small base station 304, managing component 320 can use the utility function and/or policies to determine one or more front links for communicating with small base station 304 (e.g., instead of or in addition to small base station 304 making such a determination, as described in FIG. 2, for example). In yet another example, device managing component 316 can generate and push one or more management functions that facilitate compliance with one or more policies received from service provider 302.

In another example, management information receiving component 314 can generate ad-hoc management functions, utility functions, one or more policies, etc. for device 306 based at least in part on device information received or otherwise measured by device information component 312. In this example, device managing component 316 can perform one or more functions with respect to device 306 based at least in part on the management function, utility function, one or more policies, etc. Additionally or alternatively, as described, device managing component 316 can forward the management function, utility function, one or more policies, etc. to device 306 for local performance. In addition, device managing component 316 can have conflict resolution to determine device 306 behavior when conflicting functions or policies are received from service provider 302 and generated by small base station 304.

As described in a previous specific example, device 306 can be a home appliance or home management system (e.g., a smart grid home power management system or related device), and a management function provided to device 306 can relate to powering off one or more devices, as can one or more related utility functions or policies. In this example, management information receiving component 314 can obtain the management function from service provider 302, a configuration, and/or the like. Device managing component 316 can provide the management function, related utility functions or policies, and/or a portion thereof to device 306. In one example, device managing component 316 can provide the management function of modifying power to device 306, and use the utility functions and/or policies for determining when to cause device 306 to execute the management function. In this regard, management information receiving component 318 can obtain the management function, and managing component 320 can modify power of device 306 according to the management function and/or based at least in part on the management function receiving further information from small base station 304. In another example, device managing component 316 can further push the utility functions and/or policies to device 306 for local performance, as described. Moreover, in one example, device managing component 316 can combine outputs of the utility function and one or more other utility functions, such as those described above, to determine an action for managing device 306.

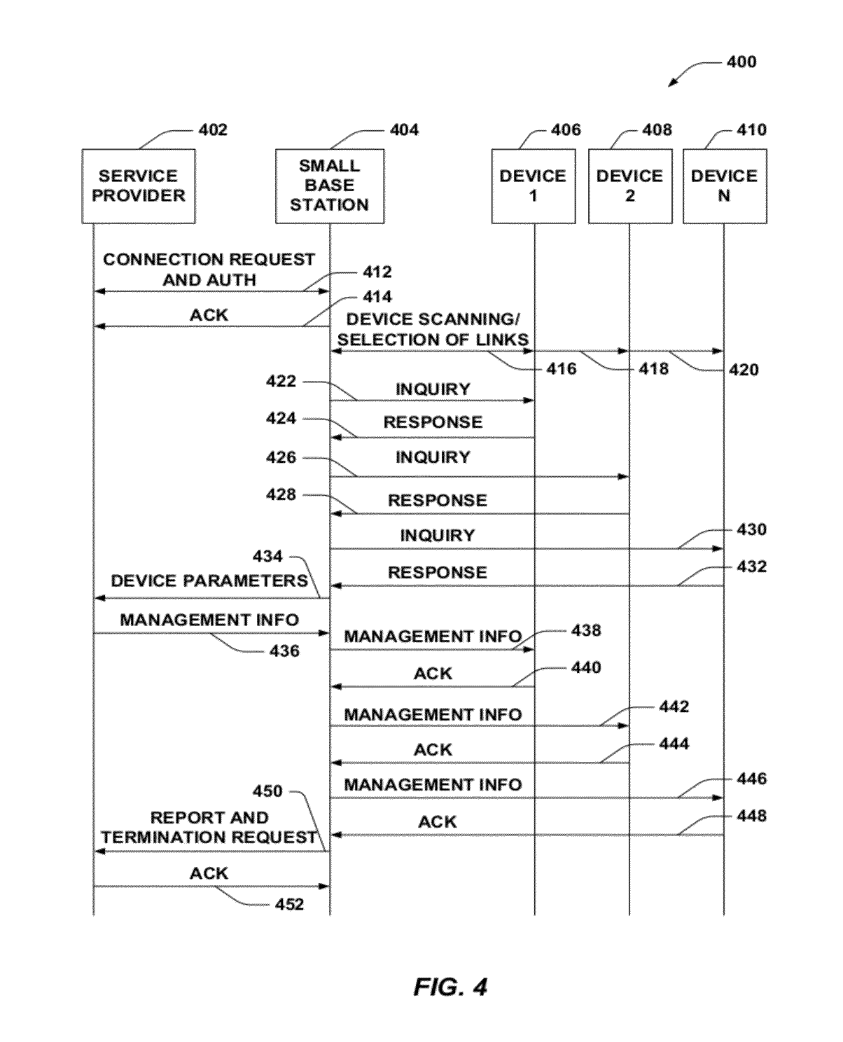

Turning to FIG. 4, an example communications system 400 that facilitates provisioning management information from a service provider to one or more devices is illustrated. System 400 includes a service provider 402 that facilitates providing one or more services to one or more devices, a small base station 404 that allows one or more devices to access the service provider 402, and device 1 406, device 2 408, device N 410, etc., that can communicate with small base station 404 to access service provider 402. As shown in previous figures, for example, service provider 302 can be a MNO, ISP, home management service provider, etc., small base station 304 can be a femtocell, picocell, or similar base station, a relay node, device in peer-to-peer mode, a portion thereof, etc., and device 306 can be a UE, modem (or other tethered device), a computer, server, etc., as described.

In this example, service provider 402 and small base station 404 can establish a connection through request and authentication 412. In addition, small base station 404 can transmit an acknowledge (ACK) 414 to service provider 402 for the connection. Moreover, small base station 404 can scan 416, 418, and 420 devices 406, 408, and 410, which can include receiving parameters related thereto, and can select 416, 418, and 420 front and/or backhaul links for devices 406, 408, and 410 (e.g., based at least in part on the received parameters), as described. Furthermore, as described previously, small base station 404 can transmit an inquiry 422 to device 1 406 to obtain one or more parameters regarding capabilities, functionality, availability, and/or the like of device 1 406, and can receive a response 424 therefrom, which can include one or more parameters. Similarly, small base station 404 can transmit the inquiry 426 to device 2 408 and receive a response 428, and transmit the inquiry 430 to device N 410 and receive a response 432.

In this regard, small base station 404 can gather at least a portion of the responses and send the responses, or parameters derived from the response regarding device capabilities, etc. as device parameters 434 to service provider 402. Service provider 402, as described, can generate management information based at least in part on the device parameters, which can include a management function, utility function, one or more policies, etc. for the devices. Service provider 402 can transmit the management information 436 to small base station 404. Small base station 404 can transmit at least a portion of the management information 438, or information derived from the received management information, to device 406, and can receive ACK 440 therefrom. For example, the management information 438 can relate to a management function to perform at device 1 406 to attain a utility function and/or one or more policies provisioned to small base station 404. Similarly, small base station 404 can transmit management information 442 to device 2, receiving ACK 444, and management info 446 to device N 410, receiving ACK 448. In addition, for example, small base station 404 can transmit a report and termination request 450 to service provider 402. The report can include, for example, feedback from the devices 406, 408, and/or 410 regarding the management information, and/or the like. Service provider 402 can transmit an ACK 452 to small base station 404 for the connection termination.

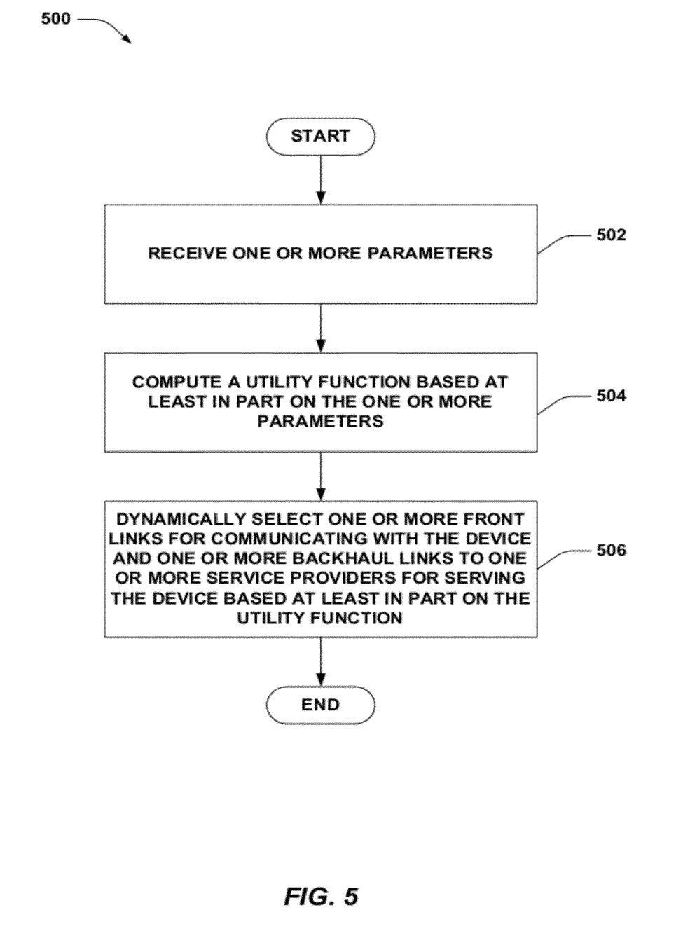

Referring to FIGS. 5-8, example methodologies relating to selecting communication links for a device are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

Referring to FIG. 5, an example methodology 500 is displayed that facilitates selecting one or more links for communicating with a device. At 502, one or more parameters can be received. As described, the one or more parameters can be received from a device, from a service provider, determined or measured, and/or the like. Moreover, the one or more parameters can relate to one or more device capabilities, a battery status, a content request, a quality-of-service, a data rate, or a latency, subscriber account limitations, a local resource availability at a small base station, resource availability on one or more of the backhaul links, SNR of the one or more backhaul links, network traffic, time of day, date, etc. At 504, a utility function can be computed based at least in part on the one or more parameters. As described, the utility function can relate to selecting one or more communication links for the device based at least in part on the one or more parameters. Thus, at 506, one or more front links for communicating with the device and one or more backhaul links to one or more service providers for serving the device can be dynamically selected based at least in part on the utility function. As described, in one example, the utility function can output one or more communication links to select to comply with the utility function (e.g., maximize data throughout depending on battery life, in one example described above). In addition, as described, the one or more links can be dynamically selected further based at least in part on one or more policies that restrict or override the utility function.

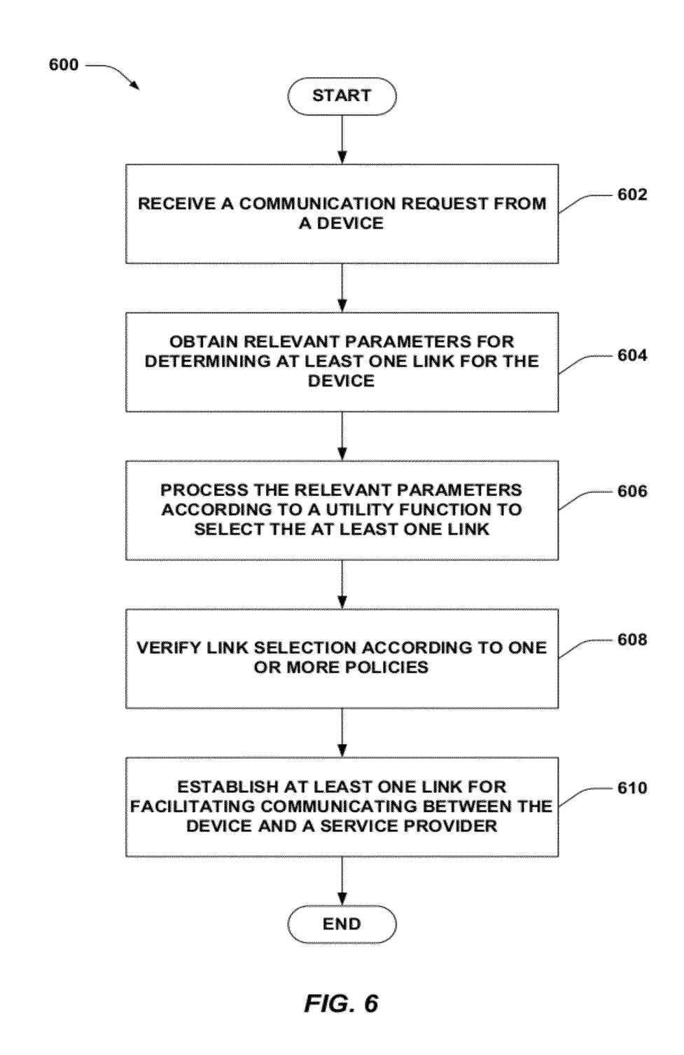

Turning to FIG. 6, an example methodology 600 is displayed that facilitates establishing one or more links for communicating with a device. At 602, a communication request can be received from a device. For example, this can include a request to establish connection to communicate with one or more service providers related to the device, which can be an MNO, ISP, web server, etc., as described. At 604, relevant parameters can be obtained for determining at least one link for the device. As described, the relevant parameters can be various parameters related to the device, the service provider, locally determined or measured parameters, and/or the like. At 606, the relevant parameters can be processed according to a utility function to select the at least one link. As described, the utility function can also be received from the device, service provider, or locally defined (e.g., from a hardcoding, network specification, configuration, etc.) and can utilize the parameters to compute one or more links to establish with the device. At 608, the link selection can be verified according to one or more policies. As described, in this regard, the one or more policies can restrict or override the link selection of the utility function. At 610, at least one link can be established for facilitating communicating between the device and the service provider.

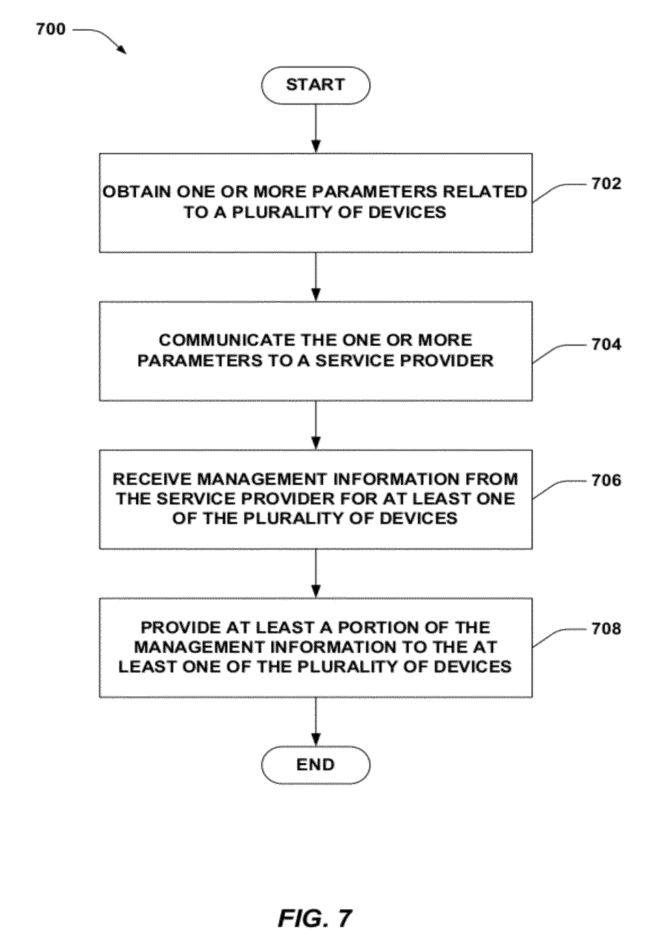

Referring to FIG. 7, illustrated is an example methodology 700 for providing management information to one or more devices. At 702, one or more parameters related to a plurality of devices can be obtained. For example, as described, the parameters can be measured from the plurality of devices, and can be based at least in part on a request from a service provider. At 704, the one or more parameters can be communicated to a service provider. For example, the service provider can analyze the one or more parameters to generate management information for the one or more devices, which can include a management function, utility function, one or more policies, and/or the like, as described. At 706, management information can be received from the service provider for at least one of the plurality of devices. At 708, at least a portion of the management information can be provided to the at least one of the plurality of devices. For example, this can include providing different management information based at least in part on the received management information (e.g., one or more management functions to ensure compliance with a received policy, etc.), as described.

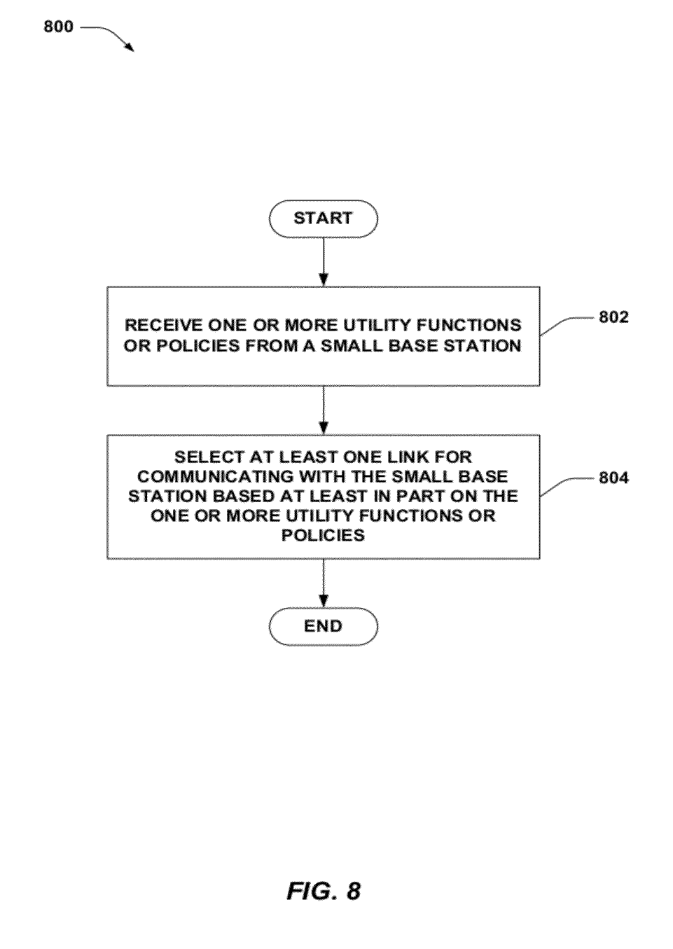

Turning to FIG. 8, an example methodology 800 is displayed that facilitates selecting one or more communication links based at least in part on received utility functions or policies. At 802, one or more utility functions or policies can be received from a small base station. As described, for example, the one or more utility functions or policies can be received from a small base station, which can generate the utility function or policies locally, receive the utility functions or policies from a service provider, and/or the like. At 804, at least one link can be selected for communicating with the small base station based at least in part on the one or more utility functions or policies. Thus, an entity that pushes the one or more utility functions or policies can control link selection in this regard, as described.

It will be appreciated that, in accordance with one or more aspects described herein, inferences can be made regarding determining or computing the utility function, enforcing one or more policies, and/or the like, as described. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

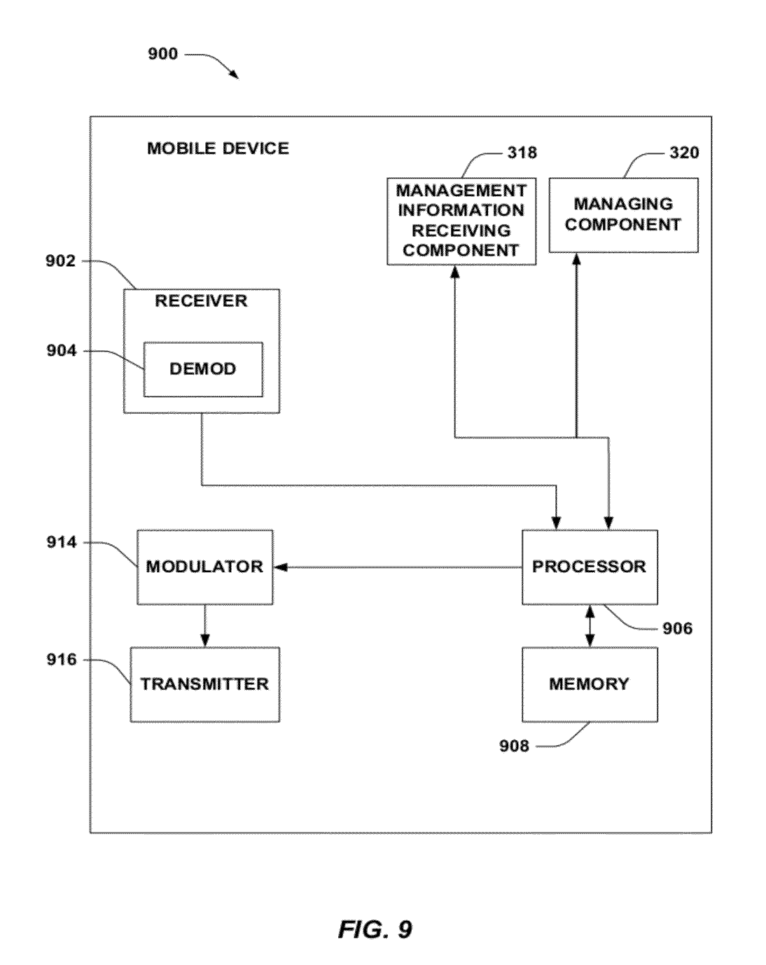

FIG. 9 is an illustration of a mobile device 900 that facilitates receiving and utilizing management information. Mobile device 900 comprises a receiver 902 that receives a signal from, for instance, a receive antenna (not shown), performs typical actions on (e.g., filters, amplifies, downconverts, etc.) the received signal, and digitizes the conditioned signal to obtain samples. Receiver 902 can comprise a demodulator 904 that can demodulate received symbols and provide them to a processor 906 for channel estimation. Processor 906 can be a processor dedicated to analyzing information received by receiver 902 and/or generating information for transmission by a transmitter 916, a processor that controls one or more components of mobile device 900, and/or a processor that both analyzes information received by receiver 902, generates information for transmission by transmitter 916, and controls one or more components of mobile device 900.

Mobile device 900 can additionally comprise memory 908 that is operatively coupled to processor 906 and that can store data to be transmitted, received data, information related to available channels, data associated with analyzed signal and/or interference strength, information related to an assigned channel, power, rate, or the like, and any other suitable information for estimating a channel and communicating via the channel. Memory 908 can additionally store protocols and/or algorithms associated with estimating and/or utilizing a channel (e.g., performance based, capacity based, etc.).

It will be appreciated that the data store (e.g., memory 908) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 908 of the subject systems and methods is intended to comprise, without being limited to, these and any other suitable types of memory.

Processor 906 can further be operatively coupled to a management information receiving component 318 that obtains management information from a small base station (not shown), which can come from or be based at least in part on a service provider, and a managing component 320 that performs one or more functions in accordance with the management information. For example, as described, the management information can relate to a management function to perform at mobile device 900, a utility function that can be computed at mobile device 900 according to one or more local parameters, one or more policies to override or restrict the utility function and/or links selected by the small base station, etc., as described. Mobile device 900 still further comprises a modulator 914 and transmitter 916 that respectively modulate and transmit signals to, for instance, a base station, another mobile device, etc. Although depicted as being separate from the processor 906, it is to be appreciated that the management information receiving component 318, managing component 320, demodulator 904, and/or modulator 914 can be part of the processor 906 or multiple processors (not shown).

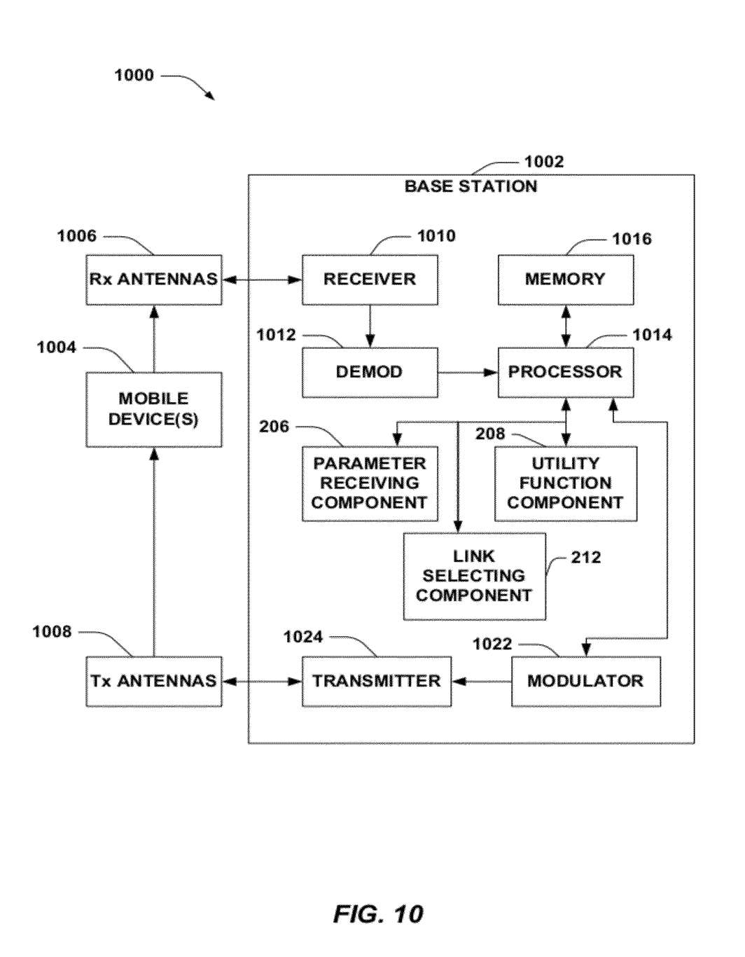

FIG. 10 is an illustration of a system 1000 that facilitates selecting one or more links for device communications. System 1000 comprises a base station 1002, which can be substantially any base station (e.g., a small base station, such as a femtocell, picocell, etc., relay node, mobile base station . . . ) having a receiver 1010 that receives signal(s) from one or more mobile devices 1004 through a plurality of receive antennas 1006 (e.g., which can be of multiple network technologies, as described), and a transmitter 1024 that transmits to the one or more mobile devices 1004 through a plurality of transmit antennas 1008 (e.g., which can be of multiple network technologies, as described). In addition, in one example, transmitter 1024 can transmit to the mobile devices 1004 over a wired front link. Receiver 1010 can receive information from one or more receive antennas 1006 and is operatively associated with a demodulator 1012 that demodulates received information. In addition, in an example, receiver 1010 can receive from a wired backhaul link. Demodulated symbols are analyzed by a processor 1014 that can be similar to the processor described above with regard to FIG. 9, and which is coupled to a memory 1016 that stores information related to estimating a signal (e.g., pilot) strength and/or interference strength, data to be transmitted to or received from mobile device(s) 1004 (or a disparate base station (not shown)), and/or any other suitable information related to performing the various actions and functions set forth herein. Processor 1014 is further coupled to a parameter receiving component 206, a utility function component 208, and a link selecting component 212, as described.

According to an example, parameter receiving component 206 can obtain one or more parameters from at least one of mobile devices 1004, one or more service providers (not shown), measuring the one or more parameters, and/or the like, as described. Utility function component 208 can determine one or more front links or backhaul links for at least one of the mobile devices 1004 based at least in part on computing a utility function from the one or more parameters. Using the utility function output, link selecting component 212 can determine at least one front link (e.g., related to the Rx antennas 1006 and Tx antennas 1008) and at least one backhaul link for the at least one device. In this example, the receiver 1010 and transmitter 1024 can also be configured to communicate with a service provider over the one or more backhaul links, as described. Moreover, for example, processor 1014 can modulate signals to be transmits using modulator 1022, and transmit modulated signals using transmitter 1024. Transmitter 1024 can transmit signals to mobile devices 1004 over Tx antennas 1008. Furthermore, although depicted as being separate from the processor 1014, it is to be appreciated that the parameter receiving component 206, utility function component 208, link selecting component 212, demodulator 1012, and/or modulator 1022 can be part of the processor 1014 or multiple processors (not shown).

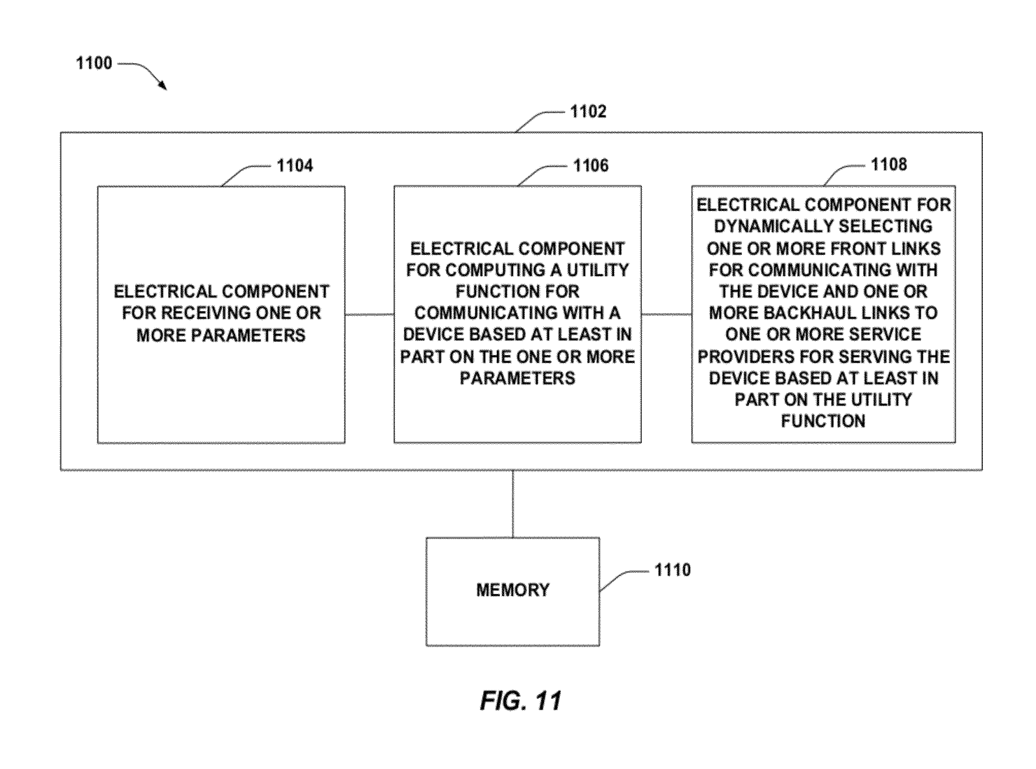

With reference to FIG. 11, illustrated is a system 1100 that selects communication links for one or more mobile devices. For example, system 1100 can reside at least partially within a base station, mobile device, etc. It is to be appreciated that system 1100 is represented as including functional blocks, which can be functional blocks that represent functions implemented by a processor, software, or combination thereof (e.g., firmware). System 1100 includes a logical grouping 1102 of electrical components that can act in conjunction. For instance, logical grouping 1102 can include an electrical component for receiving one or more parameters 1104. As described, the one or more parameters can relate to one or more device capabilities, a battery status, a content request, a quality-of-service, a data rate, or a latency, subscriber account limitations, a local resource availability at a small base station, resource availability on one or more of the backhaul links, SNR of the one or more backhaul links, network traffic, time of day, date, etc. In this regard, electrical component 1104 can receive the one or more parameters from a device or service provider, or measure/determine the one or more parameters.

Further, logical grouping 1102 can comprise an electrical component for computing a utility function for communicating with a device based at least in part on the one or more parameters 1106. As described, for example, the utility function can compute one or more links for the device based at least in part on the parameters. Furthermore, logical grouping 1102 can comprise an electrical component for dynamically selecting one or more front links for communicating with the device and one or more backhaul links to one or more service providers for serving the device based at least in part on the utility function 1108. For example, in an aspect, electrical component 1104 can include parameter receiving component 206, as described above. In addition, for example, electrical component 1106, in an aspect, can include a utility function component 208, as described above. Moreover, in an example, electrical component 1108, in an aspect, can include a link selecting component 212, as described above. Additionally, system 1100 can include a memory 1110 that retains instructions for executing functions associated with the electrical components 1104, 1106, and 1108. While shown as being external to memory 1110, it is to be understood that one or more of the electrical components 1104, 1106, and 1108 can exist within memory 1110.

In one example, electrical components 1104, 1106, and 1108 can comprise at least one processor, or each electrical component 1104, 1106, or 1108 can be a corresponding module of at least one processor. Moreover, in an additional or alternative example, electrical components 1104, 1106, and 1108 can be a computer program product comprising a computer readable medium, where each electrical component 1104, 1106, or 1108 can be corresponding code.

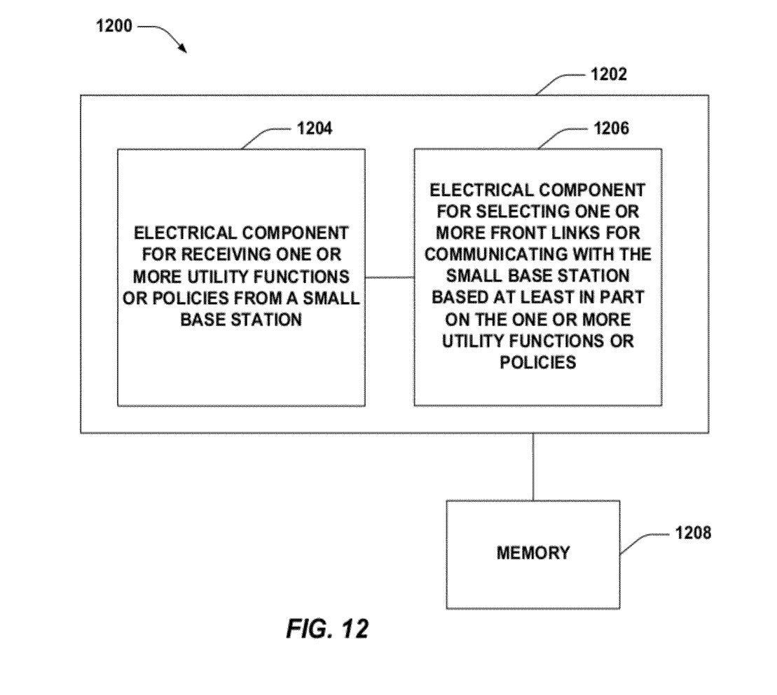

With reference to FIG. 12, illustrated is a system 1200 that utilizes management information received from a small base station. For example, system 1200 can reside at least partially within a base station, mobile device, etc. It is to be appreciated that system 1200 is represented as including functional blocks, which can be functional blocks that represent functions implemented by a processor, software, or combination thereof (e.g., firmware). System 1200 includes a logical grouping 1202 of electrical components that can act in conjunction. For instance, logical grouping 1202 can include an electrical component for receiving one or more utility functions or policies from a small base station 1204. As described, the utility functions or policies can originate at the small base station, a service provider and/or the like. Further, logical grouping 1202 can comprise an electrical component for selecting one or more front links for communicating with the small base station based at least in part on the one or more utility functions or policies 1206. Thus, the link selecting is performed locally at system 1200, in this example. For example, in an aspect, electrical component 1204 can include a management information receiving component 318, as described above. In addition, for example, electrical component 1206, in an aspect, can include a managing component 320, as described above. Additionally, system 1200 can include a memory 1208 that retains instructions for executing functions associated with the electrical components 1204 and 1206. While shown as being external to memory 1208, it is to be understood that one or more of the electrical components 1204 and 1206 can exist within memory 1208.

In one example, electrical components 1204 and 1206 can comprise at least one processor, or each electrical component 1204 and 1206 can be a corresponding module of at least one processor. Moreover, in an additional or alternative example, electrical components 1204 and 1206 can be a computer program product comprising a computer readable medium, where each electrical component 1204 and 1206 can be corresponding code.

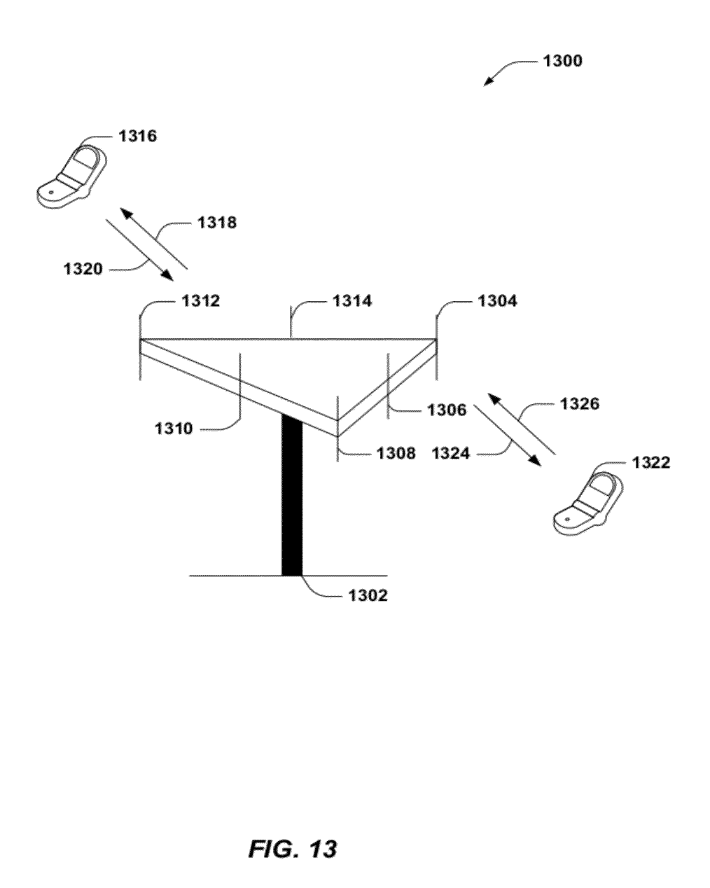

Referring now to FIG. 13, a wireless communication system 1300 is illustrated in accordance with various embodiments presented herein. System 1300 comprises a base station 1302 that can include multiple antenna groups. For example, one antenna group can include antennas 1304 and 1306, another group can comprise antennas 1308 and 1310, and an additional group can include antennas 1312 and 1314. Two antennas are illustrated for each antenna group; however, more or fewer antennas can be utilized for each group. Base station 1302 can additionally include a transmitter chain and a receiver chain, each of which can in turn comprise a plurality of components associated with signal transmission and reception (e.g., processors, modulators, multiplexers, demodulators, demultiplexers, antennas, etc.), as is appreciated.

Base station 1302 can communicate with one or more mobile devices such as mobile device 1316 and mobile device 1322; however, it is to be appreciated that base station 1302 can communicate with substantially any number of mobile devices similar to mobile devices 1316 and 1322. Mobile devices 1316 and 1322 can be, for example, cellular phones, smart phones, laptops, handheld communication devices, handheld computing devices, satellite radios, global positioning systems, PDAs, and/or any other suitable device for communicating over wireless communication system 1300. As depicted, mobile device 1316 is in communication with antennas 1312 and 1314, where antennas 1312 and 1314 transmit information to mobile device 1316 over a forward link 1318 and receive information from mobile device 1316 over a reverse link 1320. Moreover, mobile device 1322 is in communication with antennas 1304 and 1306, where antennas 1304 and 1306 transmit information to mobile device 1322 over a forward link 1324 and receive information from mobile device 1322 over a reverse link 1326. In a frequency division duplex (FDD) system, forward link 1318 can utilize a different frequency band than that used by reverse link 1320, and forward link 1324 can employ a different frequency band than that employed by reverse link 1326, for example. Further, in a time division duplex (TDD) system, forward link 1318 and reverse link 1320 can utilize a common frequency band and forward link 1324 and reverse link 1326 can utilize a common frequency band.

Each group of antennas and/or the area in which they are designated to communicate can be referred to as a sector of base station 1302. For example, antenna groups can be designed to communicate to mobile devices in a sector of the areas covered by base station 1302. In communication over forward links 1318 and 1324, the transmitting antennas of base station 1302 can utilize beamforming to improve signal-to-noise ratio of forward links 1318 and 1324 for mobile devices 1316 and 1322. Also, while base station 1302 utilizes beamforming to transmit to mobile devices 1316 and 1322 scattered randomly through an associated coverage, mobile devices in neighboring cells can be subject to less interference as compared to a base station transmitting through a single antenna to all its mobile devices. Moreover, mobile devices 1316 and 1322 can communicate directly with one another using a peer-to-peer or ad hoc technology as depicted. According to an example, system 1300 can be a multiple-input multiple-output (MIMO) communication system.

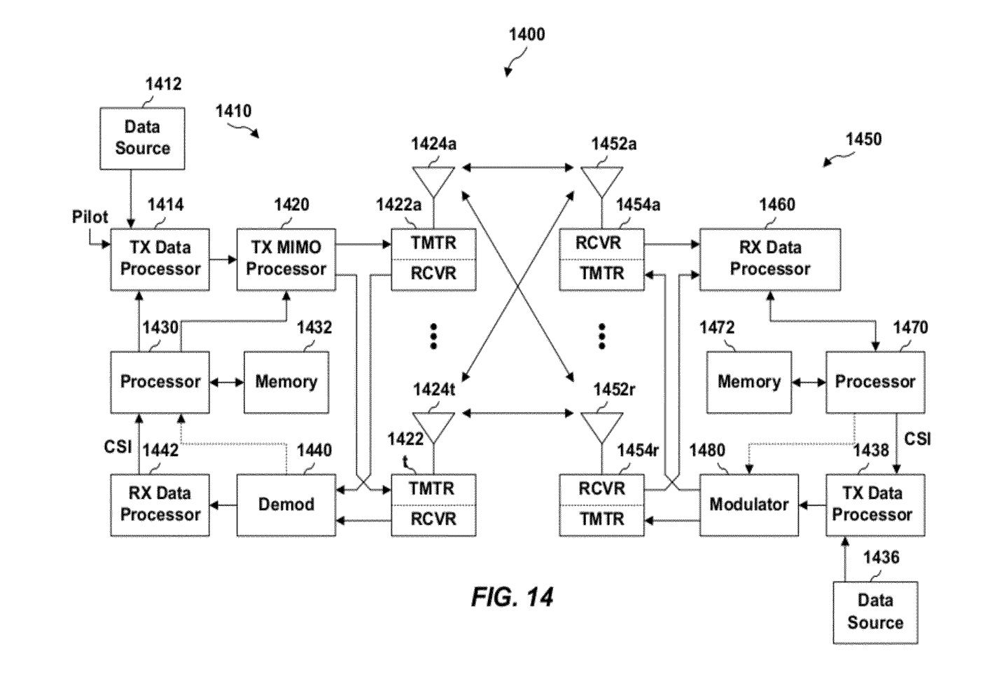

FIG. 14 shows an example wireless communication system 1400. The wireless communication system 1400 depicts one base station 1410 and one mobile device 1450 for sake of brevity. However, it is to be appreciated that system 1400 can include more than one base station and/or more than one mobile device, wherein additional base stations and/or mobile devices can be substantially similar or different from example base station 1410 and mobile device 1450 described below. In addition, it is to be appreciated that base station 1410 and/or mobile device 1450 can employ the systems (FIGS. 1-4 and 10-13), mobile devices, (FIG. 9), and/or methods (FIGS. 5-8) described herein to facilitate wireless communication there between. For example, components or functions of the systems and/or methods described herein can be part of a memory 1432 and/or 1472 or processors 1430 and/or 1470 described below, and/or can be executed by processors 1430 and/or 1470 to perform the disclosed functions.

At base station 1410, traffic data for a number of data streams is provided from a data source 1412 to a transmit (TX) data processor 1414. According to an example, each data stream can be transmitted over a respective antenna. TX data processor 1414 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 1450 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1430.

The modulation symbols for the data streams can be provided to a TX MIMO processor 1420, which can further process the modulation symbols (e.g., for OFDM). TX MIMO processor 1420 then provides NT modulation symbol streams to NT transmitters (TMTR) 1422a through 1422t. In various embodiments, TX MIMO processor 1420 applies beamforming weights to the symbols of the data streams and to the antenna from which the symbol is being transmitted.

Each transmitter 1422 receives and processes a respective symbol stream to provide one or more analog signals, and further conditions (e.g., amplifies, filters, and upconverts) the analog signals to provide a modulated signal suitable for transmission over the MIMO channel. Further, NT modulated signals from transmitters 1422a through 1422t are transmitted from NT antennas 1424a through 1424t, respectively.

At mobile device 1450, the transmitted modulated signals are received by NR antennas 1452a through 1452r and the received signal from each antenna 1452 is provided to a respective receiver (RCVR) 1454a through 1454r. Each receiver 1454 conditions (e.g., filters, amplifies, and downconverts) a respective signal, digitizes the conditioned signal to provide samples, and further processes the samples to provide a corresponding “received” symbol stream.

An RX data processor 1460 can receive and process the NR received symbol streams from NR receivers 1454 based on a particular receiver processing technique to provide NT “detected” symbol streams. RX data processor 1460 can demodulate, deinterleave, and decode each detected symbol stream to recover the traffic data for the data stream. The processing by RX data processor 1460 is complementary to that performed by TX MIMO processor 1420 and TX data processor 1414 at base station 1410.

The reverse link message can comprise various types of information regarding the communication link and/or the received data stream. The reverse link message can be processed by a TX data processor 1438, which also receives traffic data for a number of data streams from a data source 1436, modulated by a modulator 1480, conditioned by transmitters 1454a through 1454r, and transmitted back to base station 1410.

At base station 1410, the modulated signals from mobile device 1450 are received by antennas 1424, conditioned by receivers 1422, demodulated by a demodulator 1440, and processed by a RX data processor 1442 to extract the reverse link message transmitted by mobile device 1450. Further, processor 1430 can process the extracted message to determine which precoding matrix to use for determining the beamforming weights.

Processors 1430 and 1470 can direct (e.g., control, coordinate, manage, etc.) operation at base station 1410 and mobile device 1450, respectively. Respective processors 1430 and 1470 can be associated with memory 1432 and 1472 that store program codes and data. Processors 1430 and 1470 can also perform computations to derive frequency and impulse response estimates for the uplink and downlink, respectively.

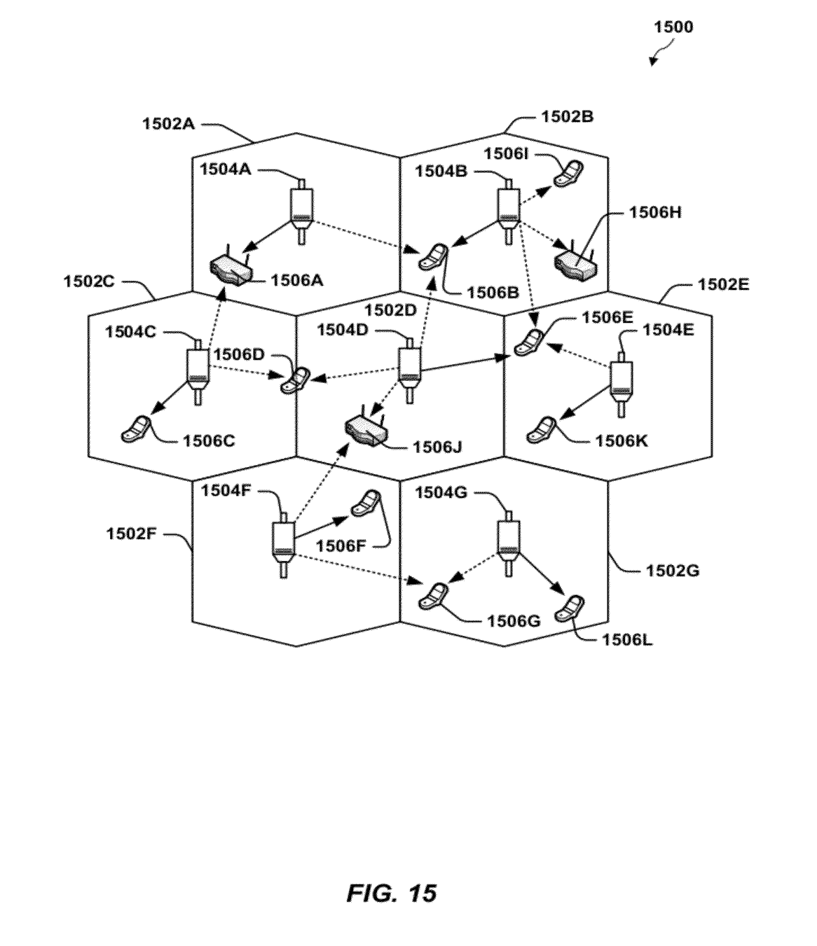

FIG. 15 illustrates a wireless communication system 1500, configured to support a number of users, in which the teachings herein may be implemented. The system 1500 provides communication for multiple cells 1502, such as, for example, macro cells 1502A-1502G, with each cell being serviced by a corresponding access node 1504 (e.g., access nodes 1504A-1504G). As shown in FIG. 15, access terminals 1506 (e.g., access terminals 1506A-1506L) can be dispersed at various locations throughout the system over time. Each access terminal 1506 can communicate with one or more access nodes 1504 on a forward link (FL) and/or a reverse link (RL) at a given moment, depending upon whether the access terminal 1506 is active and whether it is in soft handoff, for example. The wireless communication system 1500 can provide service over a large geographic region.

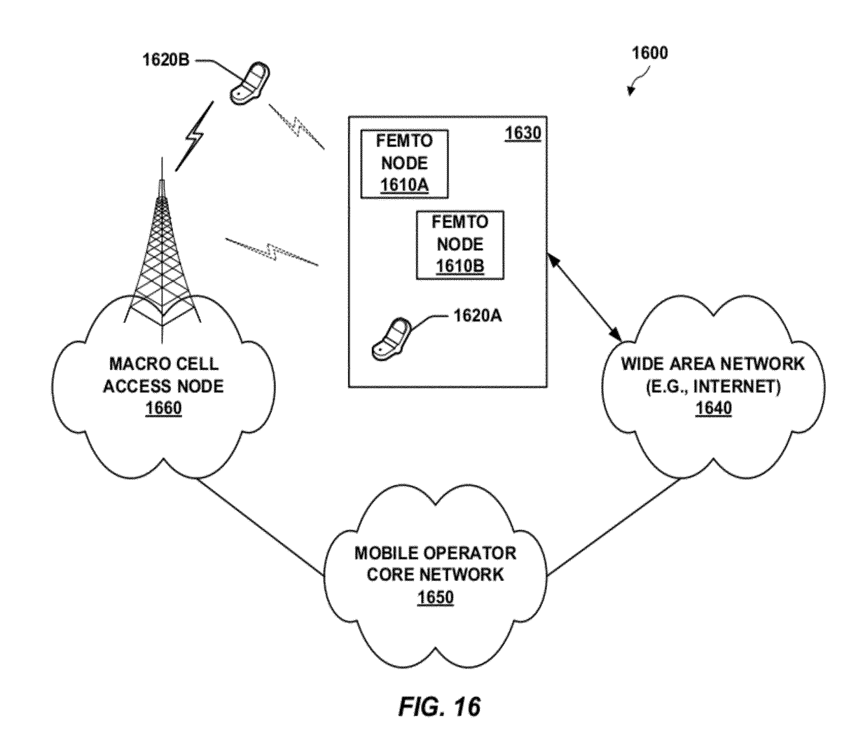

FIG. 16 illustrates an exemplary communication system 1600 where one or more femto nodes are deployed within a network environment. Specifically, the system 1600 includes multiple femto nodes 1610 (e.g., femto nodes or home Node B (HNB) 1610A and 1610B) installed in a relatively small scale network environment (e.g., in one or more user residences 1630). Each femto node 1610 can be coupled to a wide area network 1640 (e.g., the Internet) and a mobile operator core network 1650 via a digital subscriber line (DSL) router, a cable modem, a wireless link, or other connectivity means (not shown). As will be discussed below, each femto node 1610 can be configured to serve associated access terminals 1620 (e.g., access terminal 1620A) and, optionally, alien access terminals 1620 (e.g., access terminal 1620B). In other words, access to femto nodes 1610 can be restricted such that a given access terminal 1620 can be served by a set of designated (e.g., home) femto node(s) 1610 but may not be served by any non-designated femto nodes 1610 (e.g., a neighbor's femto node).

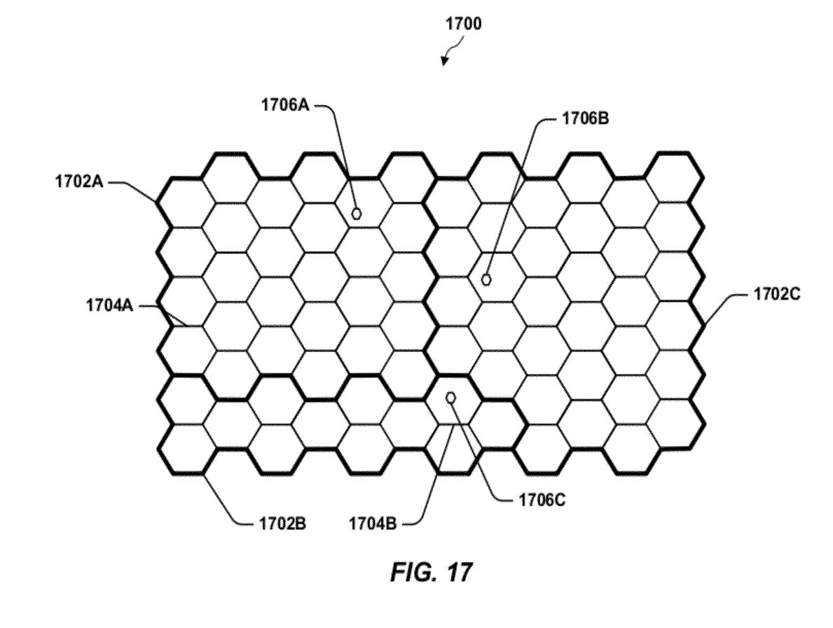

FIG. 17 illustrates an example of a coverage map 1700 where several tracking areas 1702 (or routing areas or location areas) are defined, each of which includes several macro coverage areas 1704. Here, areas of coverage associated with tracking areas 1702A, 1702B, and 1702C are delineated by the wide lines and the macro coverage areas 1704 are represented by the hexagons. The tracking areas 1702 also include femto coverage areas 1706. In this example, each of the femto coverage areas 1706 (e.g., femto coverage area 1706C) is depicted within a macro coverage area 1704 (e.g., macro coverage area 1704B). It should be appreciated, however, that a femto coverage area 1706 may not lie entirely within a macro coverage area 1704. In practice, a large number of femto coverage areas 1706 can be defined with a given tracking area 1702 or macro coverage area 1704. Also, one or more pico coverage areas (not shown) can be defined within a given tracking area 1702 or macro coverage area 1704.

Referring again to FIG. 16, the owner of a femto node 1610 can subscribe to mobile service, such as, for example, 3G mobile service, offered through the mobile operator core network 1650. In addition, an access terminal 1620 can be capable of operating both in macro environments and in smaller scale (e.g., residential) network environments. Thus, for example, depending on the current location of the access terminal 1620, the access terminal 1620 can be served by an access node 1660 or by any one of a set of femto nodes 1610 (e.g., the femto nodes 1610A and 1610B that reside within a corresponding user residence 1630). For example, when a subscriber is outside his home, he is served by a standard macro cell access node (e.g., node 1660) and when the subscriber is at home, he is served by a femto node (e.g., node 1610A). Here, it should be appreciated that a femto node 1610 can be backward compatible with existing access terminals 1620.

A femto node 1610 can be deployed on a single frequency or, in the alternative, on multiple frequencies. Depending on the particular configuration, the single frequency or one or more of the multiple frequencies can overlap with one or more frequencies used by a macro cell access node (e.g., node 1660). In some aspects, an access terminal 1620 can be configured to connect to a preferred femto node (e.g., the home femto node of the access terminal 1620) whenever such connectivity is possible. For example, whenever the access terminal 1620 is within the user's residence 1630, it can communicate with the home femto node 1610.

In some aspects, if the access terminal 1620 operates within the mobile operator core network 1650 but is not residing on its most preferred network (e.g., as defined in a preferred roaming list), the access terminal 1620 can continue to search for the most preferred network (e.g., femto node 1610) using a Better System Reselection (BSR), which can involve a periodic scanning of available systems to determine whether better systems are currently available, and subsequent efforts to associate with such preferred systems. Using an acquisition table entry (e.g., in a preferred roaming list), in one example, the access terminal 1620 can limit the search for specific band and channel. For example, the search for the most preferred system can be repeated periodically. Upon discovery of a preferred femto node, such as femto node 1610, the access terminal 1620 selects the femto node 1610 for camping within its coverage area.

A femto node can be restricted in some aspects. For example, a given femto node can only provide certain services to certain access terminals. In deployments with so-called restricted (or closed) association, a given access terminal can only be served by the macro cell mobile network and a defined set of femto nodes (e.g., the femto nodes 1610 that reside within the corresponding user residence 1630). In some implementations, a femto node can be restricted to not provide, for at least one access terminal, at least one of: signaling, data access, registration, paging, or service.

In some aspects, a restricted femto node (which can also be referred to as a Closed Subscriber Group Home Node B) is one that provides service to a restricted provisioned set of access terminals. This set can be temporarily or permanently extended as necessary. In some aspects, a Closed Subscriber Group (CSG) can be defined as the set of access nodes (e.g., femto nodes) that share a common access control list of access terminals. A channel on which all femto nodes (or all restricted femto nodes) in a region operate can be referred to as a femto channel.

Various relationships can thus exist between a given femto node and a given access terminal. For example, from the perspective of an access terminal, an open femto node can refer to a femto node with no restricted association. A restricted femto node can refer to a femto node that is restricted in some manner (e.g., restricted for association and/or registration). A home femto node can refer to a femto node on which the access terminal is authorized to access and operate on. A guest femto node can refer to a femto node on which an access terminal is temporarily authorized to access or operate on. An alien femto node can refer to a femto node on which the access terminal is not authorized to access or operate on, except for perhaps emergency situations (e.g., 911 calls).

From a restricted femto node perspective, a home access terminal can refer to an access terminal that authorized to access the restricted femto node. A guest access terminal can refer to an access terminal with temporary access to the restricted femto node. An alien access terminal can refer to an access terminal that does not have permission to access the restricted femto node, except for perhaps emergency situations, for example, 911 calls (e.g., an access terminal that does not have the credentials or permission to register with the restricted femto node).

For convenience, the disclosure herein describes various functionality in the context of a femto node. It should be appreciated, however, that a pico node can provide the same or similar functionality as a femto node, but for a larger coverage area. For example, a pico node can be restricted, a home pico node can be defined for a given access terminal, and so on.

A wireless multiple-access communication system can simultaneously support communication for multiple wireless access terminals. As mentioned above, each terminal can communicate with one or more base stations via transmissions on the forward and reverse links. The forward link (or downlink) refers to the communication link from the base stations to the terminals, and the reverse link (or uplink) refers to the communication link from the terminals to the base stations. This communication link can be established via a single-in-single-out system, a MIMO system, or some other type of system.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method of communicating over multiple link options, comprising:
receiving one or more parameters;
computing a utility function for communicating with a device based at least in part on the one or more parameters; and
dynamically selecting one or more front links for communicating with the device and one or more backhaul links to one or more service providers for serving the device based at least in part on the utility function.

2. The method of claim 1, further comprising receiving one or more policies regarding utilizing the one or more front links to communicate over the one or more backhaul links, wherein the dynamically selecting the one or more front links or the one or more backhaul links is based further at least in part on one or more policies.

3. The method of claim 2, wherein the receiving the one or more policies includes receiving the one or more policies from the one or more service providers, the device, a hardcoding, a network specification, or a configuration.

4. The method of claim 1, wherein the receiving the one or more parameters includes receiving the one or more parameters from the device.

5. The method of claim 4, wherein the one or more parameters include one or more device capabilities, a battery status, a content request, a quality-of-service, a data rate, or a latency.

6. The method of claim 1, wherein the receiving the one or more parameters includes measuring or determining the one or more parameters.

7. The method of claim 6, wherein the one or more parameters include a local resource availability, resource availability of the one or more service providers, network traffic over the one or more backhaul links, a time of day, or a date.

8. The method of claim 1, further comprising communicating one or more ad-hoc policies, one or more different ad-hoc utility functions, or the utility function to the device.

9. An apparatus for selecting link options for device communications, comprising:
at least one processor configured to:
obtain one or more parameters;
compute a utility function for a device based at least in part on the one or more parameters; and
dynamically select one or more front links for communicating with the device and one or more backhaul links to one or more service providers for serving the device based at least in part on the utility function; and
a memory coupled to the at least one processor.

10. The apparatus of claim 9, wherein the at least one processor dynamically selects the one or more front links or the one or more backhaul links based at least in part on one or more policies regarding utilizing the one or more front links to communicate over the one or more backhaul links.

11. The apparatus of claim 10, wherein the at least one processor is further configured to receive the one or more policies from the one or more service providers, the device, a hardcoding, a network specification, or a configuration.

12. The apparatus of claim 9, wherein the at least one processor obtains the one or more parameters from the device.

13. The apparatus of claim 12, wherein the one or more parameters include one or more device capabilities, a battery status, a content request, a quality-of-service, a data rate, or a latency.

14. The apparatus of claim 9, wherein the at least one processor obtains the one or more parameters at least in part by measuring or determining the one or more parameters.

15. The apparatus of claim 14, wherein the one or more parameters include a local resource availability, resource availability of the one or more service providers, network traffic over the one or more backhaul links, a current time of day, or a date.

16. The apparatus of claim 9, wherein the at least one processor is further configured to communicate one or more ad-hoc policies, one or more different ad-hoc utility functions, or the utility function to the device.

17. An apparatus for communicating over multiple link options, comprising:
means for receiving one or more parameters;
means for computing a utility function for communicating with a device based at least in part on the one or more parameters; and
means for dynamically selecting one or more front links for communicating with the device and one or more backhaul links to one or more service providers for serving the device based at least in part on the utility function.

18. The apparatus of claim 17, further comprising means for enforcing one or more policies regarding utilizing the one or more front links to communicate over the one or more backhaul links, wherein the means for dynamically selecting selects the one or more front links or the one or more backhaul links further based at least in part on the one or more policies.

19. The apparatus of claim 18, wherein the means for enforcing receives the one or more policies from the one or more service providers, the device, a hardcoding, a network specification, or a configuration.

20. The apparatus of claim 17, wherein the means for receiving receives the one or more parameters from the device.

21. The apparatus of claim 20, wherein the one or more parameters include one or more device capabilities, a battery status, a content request, a quality-of-service, a data rate, or a latency.

22. The apparatus of claim 17, wherein the means for receiving measures or determines the one or more parameters.

23. The apparatus of claim 22, wherein the one or more parameters include a local resource availability, resource availability of the one or more service providers, network traffic over the one or more backhaul links, a current time of day, or a date.

24. The apparatus of claim 17, further comprising means for communicating one or more ad-hoc policies, one or more different ad-hoc utility functions, or the utility function to the device.

25. A computer program product for selecting link options for device communications, comprising:
a computer-readable medium, comprising:
code for causing at least one computer to obtain one or more parameters;
code for causing the at least one computer to compute a utility function for a device based at least in part on the one or more parameters; and
code for causing the at least one computer to dynamically select one or more front links for communicating with the device and one or more backhaul links to one or more service providers for serving the device based at least in part on the utility function.

26. The computer program product of claim 25, wherein the code for causing the at least one computer to dynamically select dynamically selects the one or more front links or the one or more backhaul links based at least in part on one or more policies regarding utilizing the one or more front links to communicate over the one or more backhaul links.

27. The computer program product of claim 26, wherein the computer-readable medium further comprises code for causing the at least one computer to receive the one or more policies from the one or more service providers, the device, a hardcoding, a network specification, or a configuration.

28. The computer program product of claim 25, wherein the code for causing the at least one computer to obtain obtains the one or more parameters from the device.

29. The computer program product of claim 28, wherein the one or more parameters include one or more device capabilities, a battery status, a content request, a quality-of-service, a data rate, or a latency.

30. The computer program product of claim 25, wherein the code for causing the at least one computer to obtain obtains the one or more parameters at least in part by measuring or determining the one or more parameters.

31. The computer program product of claim 30, wherein the one or more parameters include a local resource availability, resource availability of the one or more service providers, network traffic over the one or more backhaul links, a current time of day, or a date.

32. The computer program product of claim 25, wherein the computer-readable medium further comprises code for causing the at least one computer to communicate one or more ad-hoc policies, one or more different ad-hoc utility functions, or the utility function to the device.

33. An apparatus for communicating over multiple link options, comprising:
a parameter receiving component for obtaining one or more parameters;
a utility function component for computing a utility function for communicating with a device based at least in part on the one or more parameters; and
a link selecting component for dynamically selecting one or more front links for communicating with the device and one or more backhaul links to one or more service providers for serving the device based at least in part on the utility function.

34. The apparatus of claim 33, further comprising a policy enforcing component for enforcing one or more policies regarding utilizing the one or more front links to communicate over the one or more backhaul links, wherein the link selecting component selects the one or more front links or the one or more backhaul links further based at least in part on the one or more policies.

35. The apparatus of claim 34, wherein the policy enforcing component receives the one or more policies from the one or more service providers, the device, a hardcoding, a network specification, or a configuration.

36. The apparatus of claim 33, wherein the parameter receiving component obtains the one or more parameters from the device.

37. The apparatus of claim 36, wherein the one or more parameters include one or more device capabilities, a battery status, a content request, a quality-of-service, a data rate, or a latency.

38. The apparatus of claim 33, wherein the parameter receiving component measures or determines the one or more parameters.

39. The apparatus of claim 38, wherein the one or more parameters include a local resource availability, resource availability of the one or more service providers, network traffic over the one or more backhaul links, a current time of day, or a date.

40. The apparatus of claim 33, further comprising a device managing component for communicating one or more ad-hoc policies, one or more different ad-hoc utility functions, or the utility function to the device.

41. A method for selecting communication links, comprising:
receiving one or more utility functions or policies from a small base station; and
selecting one or more front links for communicating with the small base station based at least in part on the one or more utility functions or policies.

42. An apparatus for selecting communication links, comprising:
at least one processor configured to:
receive one or more utility functions or policies from a small base station; and
select one or more front links for communicating with the small base station based at least in part on the one or more utility functions or policies; and
a memory coupled to the at least one processor.

43. An apparatus for selecting communication links, comprising:
means for receiving one or more utility functions or policies from a small base station; and
means for selecting one or more front links for communicating with the small base station based at least in part on the one or more utility functions or policies.

44. A computer program product for selecting communication links, comprising:
a computer-readable medium, comprising:
code for causing at least one computer to receive one or more utility functions or policies from a small base station; and
code for causing the at least one computer to select one or more front links for communicating with the small base station based at least in part on the one or more utility functions or policies.

45. An apparatus for selecting communication links, comprising:
a management information receiving component for obtaining one or more utility functions or policies from a small base station; and
a managing component for selecting one or more front links for communicating with the small base station based at least in part on the one or more utility functions or policies.
